(19) United States
(12) Patent Application Publication
(10) Pub. No.: US 2013/0337180 A1
(43) Pub. Date: Dec. 19, 2013

(54) METHOD OF FABRICATING A FRICTION PART BASED ON C/C COMPOSITE MATERIAL

(71) Applicants: Pascale Jacquemard, Saint Pierre de Chandleu (FR); Sandrine Baud, Lyon (FR); René Pailler, Cestas (FR); Florian Fontaine, Bruges (FR)

(72) Inventors: Pascale Jacquemard, Saint Pierre de Chandleu (FR); Sandrine Baud, Lyon (FR); René Pailler, Cestas (FR); Florian Fontaine, Bruges (FR)

(73) Assignee: Messier-Bugatti-Dowty, Velizy-Villacoublay (FR)

(21) Appl. No.: 13/884,468

(22) PCT Filed: Nov. 10, 2011
(86) PCT No.: PCT/FR2011/052616

§ 371 Date: Aug. 21, 2013

(30) Foreign Application Priority Data
Nov. 10, 2010 (FR) 1059278

(51) Int. Cl. C04B 41/45

(52) U.S. Cl. CPC C04B 41/456
USPC 427/372.2

(57) ABSTRACT

A fiber preform made of carbon fibers is densified with a carbon matrix in a plurality of separate stages. After a first densification stage and before the end of carbon matrix densification, ceramic particles are introduced in order to be dispersed within the composite material part. The introduced particles have a mean size of less than 250 nm and are made at least of a ceramic compound of an element selected from titanium, yttrium, tantalum, and hafnium, the ceramic compound being selected from oxides, nitrides, and mixed oxide, carbide, and/or nitride compounds that do not react with carbon at a temperature of less than 1000° C. and that have a melting point higher than 1800° C.

### BACKGROUND OF THE INVENTION

The invention relates to friction parts based on carbon/carbon (C/C) composite material, in particular airplane brake disks.

C/C composite material airplane brake disks are in widespread use. The fabrication of such disks conventionally comprises a step of preparing a fiber preform made of carbon fibers and having a shape that is close to that of the disk that is to be fabricated, the preform serving to constitute the fiber reinforcement of the composite material, and then the preform is densified with a carbon matrix.

A well-known method of making a fiber preform out of carbon fibers comprises superposing fiber plies made of carbon-precursor fibers, e.g. of pre-oxided polyacrylonitrile (PAN), bonding the plies together, e.g. by needling, and performing carbonization heat treatment in order to transform the precursor into carbon. Reference may be made to document U.S. Pat. No. 5,792,715, among others.

The preform may be densified with a carbon matrix by chemical vapor infiltration (CVI). Preforms are placed in an enclosure into which a gas is admitted containing one or more carbon precursors, e.g. methane and/or propane. The temperature and the pressure inside the enclosure are controlled in order to enable the gas to diffuse within the preforms and to form therein a solid deposit of pyrolytic carbon (PyC) by one or more of the precursors decomposing. A method of densifying a plurality of annular brake disk preforms arranged in stacks is described in document U.S. Pat. No. 5,904,957, among others.

Densification with a carbon matrix may also be performed by a liquid technique, i.e. by impregnating the preform with a carbon precursor, typically a resin, and pyrolyzing the precursor, with it being common practice to perform a plurality of impregnation and pyrolysis cycles.

A method of densification involving “vaporization” is also known in which a disk preform for densifying is immersed in a bath of carbon precursor, e.g. of toluene, and is heated, e.g. by inductive coupling, so that the precursor vaporizes in contact with the preform and diffuses within it in order to form a PyC deposit by decomposition. Such a method is described in document U.S. Pat. No. 5,389,152, among others.

Among the various properties looked for in brake disks based on C/C composite material, it is highly desirable to have low wear.

In order to improve wear resistance, many proposals have been made to introduce ceramic precursors in the C/C composite material.

Thus, document U.S. Pat. No. 6,376,431 describes impregnating a carbon fiber preform with a sol-gel type solution containing a precursor for silica (SiO₂) that, after heat treatment and chemical reaction with the carbon, leaves particles of silicon carbide (SiC) distributed within the preform, those particles representing no more than 1% by weight in the final C/C composite material.

Document WO 2006/067184 recommends performing impregnation by means of a sol-gel type solution or a colloidal suspension on the carbon fiber texture of the plies that are used for making the preform in order to obtain a dispersion of grains of oxides such as the oxides of titanium (TiO₂), of zirconium (ZrO₂), of hafnium (HfO₂), and of silicon (SiO₂). Subsequent heat treatment transforms those oxide grains into carbide grains by reaction with the carbon of the fibers. Tests performed with silicon carbide grains reveal a reduction in wear at high temperature in comparison with C/C composite materials obtained without introducing ceramic grains. Nevertheless, wear at low temperature is significantly higher. Unfortunately, with airplane brake disks, it has been observed that wear takes place mainly when braking while taxiing when cold, on the path between a parking location and the takeoff runway. In addition, the transformation into carbides consumes carbon from the fibers of the reinforcement.

Document EP 1 748 036 describes impregnating a carbon fiber substrate with a slip containing a carbon precursor resin and grains of metal oxide, e.g. SiO₂, TiO₂, ZrO₂, . . . . After heat treatment, a C/C composite material is obtained that contains carbide grains obtained by transforming oxide particles, thereby consuming carbon from the fibers. The examples specify using oxide grains of a size of several micrometers.

Document U.S. Pat. No. 5,962,135 describes impregnating a brake disk fiber preform with a colloidal solution of silica or of aluminum monohydroxide (AlO(OH)) in order to form SiC or aluminum nitride (AlN) after heat treatment. It is to be feared that the fibers of the preform are degraded, thereby degrading the mechanical properties of the brake disks.

Document WO 2006/29097 describes impregnating a brake disk preform with a composition containing a ceramic precursor and an acid phosphate or impregnating a C/C brake disk with a suspension of ceramic particles and an acid phosphate.

Document EP 0 507 564 describes making a part out of C/C type composite material by mixing carbon-containing fibers, ceramic powder, and carbon powder, molding and sintering, the ceramic powder being constituted for example by an oxide such as SiO₂, TiO₂, ZrO₂, . . . , or a nitride. The use of a powder of ZrO₂ made up of one-micrometer grains is mentioned in Example 2, the quantity of ZrO₂ in the final composite material being 6.2%.

Document EP 0 404 571 describes a method similar to that of EP 0 507 564, but for forming a sliding part having a low coefficient of friction.

### OBJECT AND SUMMARY OF THE INVENTION

The present invention seeks to propose a method enabling a friction part to be obtained that is based on C/C composite material with improved properties, and in particular a friction part presenting low wear at low temperatures.

This object is achieved by a method of the type comprising making a preform out of carbon fibers, densifying the preform with a carbon matrix, where densification is performed in a plurality of separate stages, and during the fabrication process, introducing ceramic particles that are dispersed within the part in which method, the introduced particles have a mean size of less than 250 nanometers (nm) and are made of at least one ceramic compound of an element selected from titanium, yttrium, tantalum, and hafnium, the ceramic compound being selected from oxides, nitrides, and mixed oxide, carbide, and/or nitride compounds that do not react with carbon at a temperature lower than 1000° C. and that have a melting point higher than 1800° C., and the introduction of the ceramic particles is performed after a first densification stage and before the end of densification with the carbon matrix.

The term “mixed oxide, carbide, and/or nitride compounds” is used herein to mean oxycarbides, oxynitrides, or oxycarbonitrides having the composition M-Cₓ—O_{y}—N_{z}, where M is a metal and x, y, and z are numbers such that y and z are not both simultaneously zero.

The particles have a mean size that is small and less than 250 nm, preferably lying in the range 50 nm to 150 nm.

Preferably, the introduction of ceramic particles comprises a step of impregnation by means of a colloidal solution of at least one ceramic compound or of impregnation with a sol-gel type solution containing at least one ceramic compound precursor.

The sol-gel type solution or the colloidal solution may also contain at least one carbon precursor, e.g. saccharose.

Preferably, particles of at least one ceramic compound are introduced so as to constitute a percentage by weight of the composite material that lies in the range 1% to 10%.

In a particular implementation, the introduction of particles of at least one ceramic compound comprises a step of impregnation by a colloidal solution of at least one oxide or of impregnation by a sol-gel type solution containing at least one oxide precursor, in order to obtain a dispersion of particles of at least one oxide, and nitriding treatment is performed in order to transform the oxide particles into nitride particles, at least in part.

As can be seen from the detailed description below, the method of the invention is remarkable in that the addition of particles of at least one ceramic compound in the manner specified enables a large reduction to be obtained in friction wear at low temperature. The small size of the particles enables them to be better dispersed within the composite material so as to achieve better effectiveness. Furthermore, introducing ceramic particles at an intermediate stage of densification avoids direct contact with the reinforcing fibers and potential consumption of the carbon of the fibers during heat treatment performed during the fabrication of the friction part, and also encourages dispersion within the carbon matrix.

### BRIEF DESCRIPTION OF THE DRAWINGS

The invention can be better understood on reading the following description given by way of non-limiting indication. Reference is made to the accompanying drawings, in which:

FIG. 1 shows successive steps of a particular implementation of a method of the invention;

FIGS. 2 and 3 show successive steps of other particular implementations of a method of the invention; and

FIGS. 4 and 5 are graphs showing curves plotting wear as a function of temperature for various examples of friction parts obtained by the invention or otherwise.

### DETAILED DESCRIPTION OF IMPLEMENTATIONS

In the description below, attention is given more particularly to making disks based on C/C composite material for airplane brakes. Nevertheless, the invention is applicable to other friction parts based on C/C composite material, such as brake disks for land vehicles, in particular automobiles, and friction parts other than disks, in particular pads.

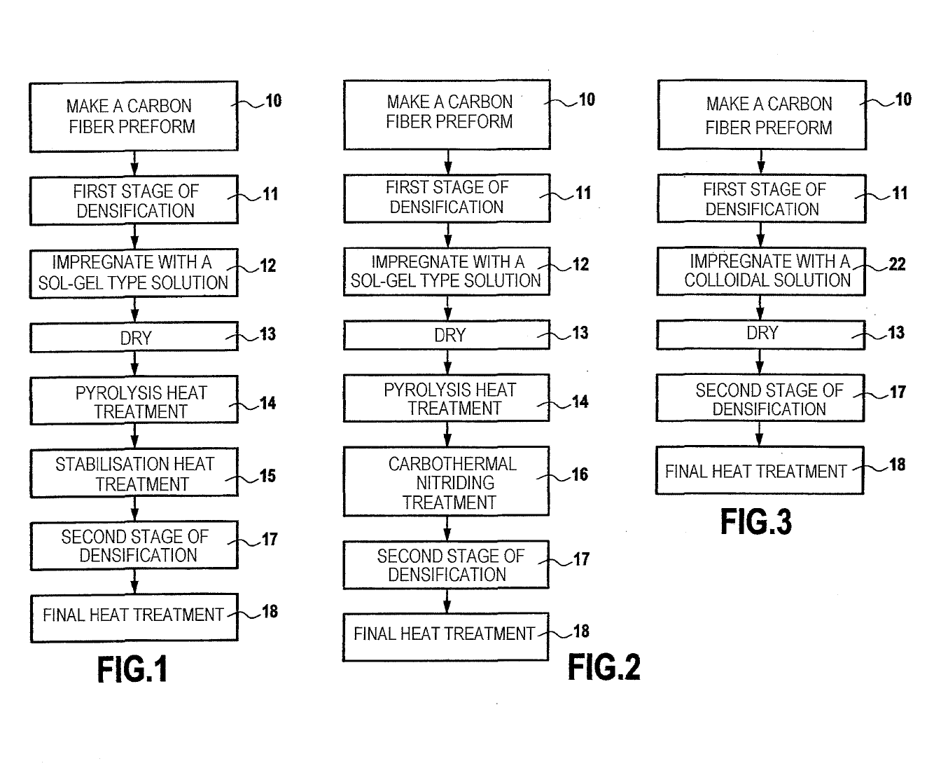

First and second implementations of a method of the invention are shown in FIGS. 1 and 2.

A first step 10 consists in making an annular preform of carbon fibers for a brake disk. By way of example, such a preform may be made by superposing plies that have been cut out from a fiber texture made of carbon-precursor fibers, the plies being bonded together by needling, the preform then being cut out, and the carbon precursor then being transformed into carbon by heat treatment. In a variant, it is also possible to make an annular preform by winding a helical fabric of carbon precursor fibers to form superposed turns, bonding the turns together by needling, and transforming the precursor by heat treatment. By way of example, reference may be made to the following documents: U.S. Pat. No. 5,792,715, U.S. Pat. No. 6,009,605, and U.S. Pat. No. 6,363,593. It is also possible to make preforms directly from annular plies of fiber textures made of carbon fibers that are superposed and bonded together, e.g. by needling.

In step 11, partial densification by means of a carbon matrix is performed, e.g. by a CVI process using a gas containing methane and/or propane. CVI densification is performed in an enclosure at a temperature of about 1000° C. and at a pressure that is preferably less than 5 kilopascals (kPa), as is already well known. By way of example, reference may be made to above-mentioned document U.S. Pat. No. 5,904,957. This first densification stage is performed preferably so as to fill in 10% to 60% by volume of the initial porosity of the preform. In a variant, the first densification stage may be performed by a liquid type method or a vaporization type method, as mentioned above.

In step 12, the partially densified preform is impregnated with a liquid made up of a sol-gel type solution comprising one or more precursors enabling small-sized grains or particles of ceramic to be formed and dispersed within the preform, i.e. having a mean dimension of less than 250 nm, and preferably lying in the range 50 nm to 150 nm. The composition of the solution is determined so as to end up with at least one ceramic compound:

of an element selected from titanium, yttrium, tantalum, and hafnium;

selected from among oxides, nitrides, and mixed oxide, carbide, and nitride compounds (oxynitrides, oxycarbides, carbonitrides, oxycarbonitrides);

that does not react with carbon at a temperature lower than 1000° C.;

that has a melting point higher than 1800° C.;

in such a manner as to avoid reacting with the carbon of the C/C composite material under normal conditions of preparation and utilization of brake disks, and to avoid passing to the liquid state during the heat treatments to which the brake disks are subjected while they are being prepared or during emergency braking such as upon a rejected takeoff (RTO).

Examples of sol-gel type solutions that enable such ceramic compounds to be obtained are described below. In general, it is possible to use at least one oxide precursor dissolved in a solvent, preferably with added chelating agent, one or more oxides or oxycarbides being obtained after drying by eliminating the solvent and heat treatment, the carbon for optionally forming at least one oxycarbide coming from the carbon matrix formed during the first densification stage. At least one nitride, oxynitride, or oxycarbonitride may be obtained by subsequent nitriding, in particular by carbothermal nitriding.

The sol-gel type solution may also include a carbon precursor that is useful in particular for adding to the carbon matrix or for providing the carbon needed for carbothermal nitriding so as to avoid consuming the previously-deposited carbon of the matrix. As a carbon precursor, it is advantageously possible to use saccharose, it being understood that other precursors could be used, such as methylcellulose, fructose, or glucose.

Performing impregnation with a sol-gel type solution at an intermediate stage in the densification of the C/C composite material, instead of at the non-densified fiber preform stage, enables ceramic particles to be dispersed better within the volume of the matrix, avoiding them becoming confined at the fiber-matrix interface. Furthermore, possible consumption of the carbon of the fibers is avoided during heat treatment performed for making the ceramic particle enriched C/C composite material, in particular during a carbothermal nitriding treatment.

In step 13, drying is performed, e.g. at a temperature lying in the range 60° C. to 100° C. and for a duration of one to several tens of hours, where drying may be performed in a stove.

In step 14, heat treatment is performed to transform the precursor(s) into oxide(s). This pyrolysis heat treatment may be performed under a non-oxidizing atmosphere, e.g. an atmosphere of nitrogen or of argon, or under a vacuum, and at a temperature lying for example in the range 600° C. to 1000° C. for one to several tens of hours. When it is desired to obtain particles of oxide(s) (FIG. 1) and an oxide as obtained in this way is unstable, it is preferable to perform stabilization heat treatment (step 15). This stabilization treatment is preferably performed at a temperature lying in the range 1000° C. to 1500° C. for one to several hours and under an inert atmosphere. The conditions of the heat treatment(s) are selected so as to avoid total carbiding of the oxide(s), i.e. so as to avoid them being transformed completely into carbides by reacting with the carbon of the matrix, while forming oxycarbides is nevertheless possible in the context of the invention.

After the heat treatment of step 14 and the optional heat treatment of step 15, carbon matrix densification is completed during a second densification stage (step 17) that may be similar to the first stage of step 11, or different from the latter, e.g. with a first stage of densification by CVI and a second stage of densification using a liquid technique, or vice versa.

In step 18, it is possible in known manner to perform high temperature heat treatment of the ceramic particle enriched C/C composite brake disk. Such final heat treatment is performed under an inert atmosphere or under a vacuum at a temperature higher than 1400° C.

When it is desired to obtain particles of nitride, oxynitride, or oxycarbonitride (FIG. 2) after the heat treatment of step 14, a nitriding treatment such as carbothermal nitriding is performed (step 16). The nitriding treatment is performed under an atmosphere of nitrogen or of ammonia gas, e.g. at atmospheric pressure, during one to several hours and at a temperature that is a function of the compounds to be formed, and that typically lies in the range 900° C. to 1700° C.

In the implementation of FIGS. 1 and 2, carbon matrix densification is performed in two stages that are separated by steps of impregnation with a sol-gel type solution and of heat treatment(s). It is possible to perform densification in more than two stages, with successive steps of impregnation with a sol-gel type solution and of heat treatment(s) being performed between two densification stages during each gap between two stages or during only one or a few of those gaps.

The method of FIG. 3 differs from that of FIG. 1 in that, after the first densification stage (step 11), the impregnation in step 22 is performed by means of a colloidal suspension and not by a sol-gel type solution as in step 12.

A colloidal solution is used that is suitable, after drying and possible heat treatment, for leaving particles of oxide, of nitride, and/or of mixed compounds as defined above.

In particular, it is possible to use a colloidal suspension of at least one oxide. After drying (step 13), the pyrolysis and stabilization heat treatments of FIG. 1 are omitted unless heat treatment is needed for pyrolyzing or eliminating organic additives present in the suspension or for carbonizing the saccharose that might have been added to the suspension. Thereafter, the method passes on to the second densification stage (step 17) and to the final heat treatment, if any (step 18).

In order to obtain particles of nitride or of mixed compound including a nitride, nitriding heat treatment is performed after drying and before the second densification stage, such as the treatment of step 16 in FIG. 2.

It should be observed that several impregnation/drying/pyrolysis cycles may be performed in the context of the above-described methods, together with only one stabilization or nitriding treatment, in order to modulate the quantity of ceramic compound particles introduced.

It should also be observed that impregnation may be performed by using a sol-gel type solution and by using a colloidal suspension, either simultaneously or at respective different stages in the fabrication of the brake disks.

It is here preferred to form ceramic compound particles from an impregnation with a sol-gel type solution or with a colloidal suspension because of the ease with which that can be done. Nevertheless, other ways of introducing ceramic compound particles may be used in the context of the invention, e.g. impregnation by ceramic compound particles dispersed in a resin, a chemical vapor deposition or chemical vapor infiltration process (CVD or CVI), impregnation with an organic precursor of a ceramic compound followed by pyrolysis for transforming the precursor, and more generally any other known technique for introducing particles of nanometric size.

For example, titanium nitride (TiN) particles may be formed by pyrolysis or by CVI/CVD from an organic precursor such as tetrakis (dimethylamide) titanium (TDEAT-[(C₂H₅)₂N]₄Ti).

The description above relates to introducing ceramic compound particles after a first cycle of densification and before the end of densification with the carbon matrix. Nevertheless, that does not exclude introducing additional ceramic particles after the end of densification.

### EXAMPLE 1

### Comparative

Airplane brake disks of C/C composite material were fabricated as follows.

Fiber preforms were made by superposing and needling fiber texture plies made of fibers of pre-oxidized PAN, a carbon precursor, as described in document U.S. Pat. No. 5,792,715. The fiber texture was in the form of a multiaxial sheet obtained by Superposing and lightly needling three unidirectional sheets in directions forming angles of 60° relative to one another. After carbonizing the precursor, carbon fiber preforms were obtained with a fiber volume fraction of about 25% (percentage of the apparent volume of the preform occupied by the fibers).

Thereafter, each preform was densified with a PyC matrix obtained by CVI, the final density of the composite material being greater than or equal to 1.75. Densification was performed in two stages, the first stage reducing the volume fraction of the pores from an initial value of about 75% to a value of about 35%, i.e. by filling in about 42% of the initial porosity of the preforms. The partially densified preforms were subjected to crust removal after the first densification stage. Heat treatment at high temperature, higher than 1400° C., was performed in the final stage.

### EXAMPLE 2

Carbon fiber preforms were obtained and then subjected to a first densification stage and to crust removal as in Example 1. After crust removal, each preform was impregnated with a sol-gel type solution based on a precursor for titanium oxide TiO₂, that was prepared as follows.

In known manner, titanium butoxide was used as a TiO₂ precursor dissolved in a butanol/ethanol mixture. Acetylacetone was added as a chelating agent. A hydrochloric acid solution at 0.02 moles per liter (mol/L) was introduced into the first solution while it was being stirred. The table below gives the quantities of the various ingredients in moles.

| Titanium | | | | HCl |
|---|---|---|---|---|
| butoxide | Butanol | Ethanol | Acetylacetone | solution |
| 1 | 3 | 3 | 1 | 2 |

After stoving at 70° C. for 24 hours (h), pyrolysis heat treatment under nitrogen was performed while progressively raising the temperature up to 900° C., transforming the titanium butoxide into the oxide TiO₂ in its rutile form. Since that is stable, stabilization heat treatment was not required. TiO₂ particles were obtained having a mean dimension of about 100 nm.

Thereafter, the second densification stage was performed as in Example 1.

The quantity of sol-gel type solution was selected so as to obtain a percentage by weight of TiO₂ particles in the final composite material that was approximately equal to 2.9%.

### EXAMPLE 3

The procedure was the same as in Example 2 but with added saccharose. The table below gives the quantities in moles of the various ingredients.

| Titanium | | | | | HCl |
|---|---|---|---|---|---|
| butoxide | Butanol | Ethanol | Acetylacetone | Saccharose | solution |
| 1 | 3 | 3 | 1 | 0.2 | 2 |

In the final composite material, TiO₂ particles were obtained having a mean dimension of about 100 nm, representing a percentage by weight of about 2.6% in the final composite material.

### EXAMPLE 4

The procedure was as in Example 2, but the pyrolysis heat treatment was followed by carbothermal nitriding treatment performed under nitrogen at a temperature of 1200° C. for 4 h in order to obtain particles of titanium nitride (TiN).

Particles were obtained having a mean dimension of about 50 nm representing a percentage by weight of about 2.5% in the final composite material.

### EXAMPLE 5

The procedure was as in Example 3, but the pyrolysis treatment was followed by carbothermal nitriding treatment performed under nitrogen at a temperature of 1200° C. for 4 h in order to obtain particles of titanium nitride (TiN).

Particles were obtained having a mean dimension of about 50 nm, representing a percentage by weight of about 2.5% in the final composite material.

### EXAMPLE 6

Carbon fiber preforms were obtained and then subjected to a first stage of densification and to crust removal as in Example 1. After crust removal, each preform was impregnated with a sol-gel type solution based on a precursor for yttrium oxide Y₂O₃ that was prepared as follows.

Yttrium nitrate was used as a Y₂O₃ precursor dissolved in water. Acetic acid was added as a chelating agent. The table below gives the quantities in moles of the various ingredients.

| Yttrium nitrate | Distilled water | Acetic acid |
|---|---|---|
| 1 | 25 | 1 |

After stoving at 90° C. for 48 h, pyrolysis heat treatment under nitrogen was performed with the temperature being raised progressively up to 900° C., thereby transforming the yttrium nitrate into the oxide Y₂O₃. Since that is stable, stabilization heat treatment was not required. Y₂O₃ particles were obtained having a mean dimension of 50 nm.

The second densification stage was then performed as in Example 1.

The quantity of sol-gel type solution was selected so as to obtain a percentage by weight of Y₂O₃ in the final composite material that was equal to about 2.7%.

### EXAMPLE 7

The procedure was as in Example 6, but with added saccharose in the distilled water before dissolving the yttrium nitrate. The table below gives the quantities in moles of the various ingredients.

| Yttrium | Distilled | | |
|---|---|---|---|
| nitrate | water | Saccharose | Acetic acid |
| 1 | 25 | 0.3 | 1 |

Y₂O₃ particles were obtained having a mean dimension of 50 nm, the quantity of those particles in the final composite material representing a percentage by weight of about 2.7%.

### Tests

The disks of Examples 1 to 7 were tribologically evaluated by simulating braking. Compared with the usual dimensions for airplane brake disks, the disks used were at a smaller scale having an outside diameter of 144 millimeters (mm), an inside diameter of 98 mm, and a thickness of 14 mm.

Increasing energy densities per unit mass in the range 16 kilojoules per kilograms (kJ/kg) to 500 kJ/kg were applied, while imposing initial speeds in the range 521 revolutions per minute (rpm) to 2840 rpm, with a braking pressure of 3.2 bars.

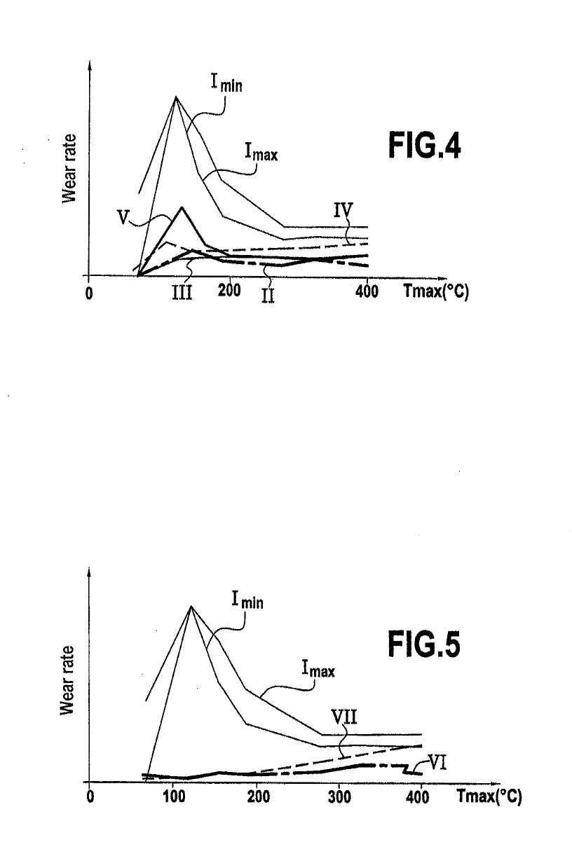

The curves of FIGS. 4 and 5 show the wear rate (reduction of thickness as a function of time) per friction face as a function of the temperature as measured by a probe located 1 mm beneath the friction face for the disks of Examples 1 to 11.

In FIGS. 4 and 5, the curves Iₘᵢₙ and Iₘₐₓ represent the envelope of the results obtained with disks of comparative Example 1.

In FIG. 4, curves II, III, IX, and V represent results obtained with the disks of Examples 2, 3, 4, and 5, respectively.

In FIG. 5, curves VI and VII represent the results obtained with the disks of Examples 6 and 7, respectively.

When using disks in accordance with the invention, it can be seen in all of the examples that there is a very great reduction in low-temperature wear, in particular at temperatures lower than 200° C.

1. A method of fabricating a friction part based on carbon/carbon composite material, the method comprising:
making a fiber preform out of carbon fibers;
densifying the preform with a carbon matrix, densification being performed in a plurality of separate stages, and during the fabrication process, introducing ceramic particles into the partially densified preform, wherein the introduction of ceramic particles takes place after a first stage of densifying the fiber preform with the carbon matrix and before the end of densifying with the carbon matrix, and comprises impregnating with a colloidal solution of at least one ceramic compound, or impregnating with a sol-gel type solution containing at least one ceramic compound precursor, followed before continuing with the densification by means of the carbon matrix, by a treatment for transforming the precursor into a ceramic compound by reacting with the carbon of the matrix without complete transformation into carbide,
wherein in order to obtain ceramic compound particles having an average size of less than 250 nm, the ceramic compound constituting the particles being at least one compound of an element selected from titanium, yttrium, tantalum, and hafnium, and being selected from oxides, nitrides, and mixed oxide, carbide, and/or nitride compounds that do not react with carbon at a temperature lower than 1000° C. and that have a melting point higher than 1800° C.

2. (canceled)

3. A method according to claim 1 2, wherein the introduction of particles of at least one ceramic compound comprises impregnation with a sol-gel type solution or a colloidal solution also containing at least one carbon precursor.

4. A method according to claim 3, wherein the sol-gel type solution contains saccharose.

5. A method according to claim 1, wherein particles of at least one ceramic compound are introduced to represent a percentage by weight in the composite material lying in the range 1% to 10%.

6. A method according to claim 1, wherein the introduction of particles of at least one ceramic compound comprises impregnating by a colloidal solution of at least one oxide or impregnating by a sol-gel type solution containing at least one oxide precursor, in order to obtain a dispersion of particles of at least one oxide, and nitriding treatment is performed in order to transform the oxide particles into nitride particles, at least in part.
